(19) United States
(12) Patent Application Publication
(10) Pub. No.: US 2025/0113298 A1
(43) Pub. Date: Apr. 3, 2025

(54) METHOD AND ARRANGEMENTS FOR SUPPORTING ENERGY SAVING BY A RADIO NODE

(71) Applicant: Telefonaktiebolaget LM Ericsson (publ), Stockholm (SE)

(72) Inventors: Eduardo Lins de Medeiros, Sundbyberg (SE); Miguel Berg, Sollentuna (SE); Pal Frenger, Linkoping (SE); Niklas Wernersson, Kungsangen (SE)

(21) Appl. No.: 18/725,432

(22) PCT Filed: Dec. 28, 2021
(86) PCT No.: PCT/EP2021/087729

§ 371 Date: Jun. 28, 2024

(51) Int. Cl. H04W 52/02

(52) U.S. Cl. CPC H04W 52/0206

(57) ABSTRACT

Methods, radio node (150; 900) and controller node (250; 700), to support energy saving by the radio node (150; 900). The radio node (150; 900) being controllable by the controller node (250; 700) to operate using radio related settings according to a supported operative set of radio related settings. The controller node (250; 700) sends (305; 604), to the radio node (150; 900), a message identifying first one or more subsets of said supported operative set of radio related settings. Said first one or more subsets being the only of said supported operative set that the radio node (150; 900) temporarily needs to be prepared to operate according to.

### TECHNICAL FIELD

Embodiments herein concern methods and arrangements where a controller node, such as an Open Radio Access Network Radio Unit, O-RU, controller, controls a radio node, such as an O-RU node. The radio node being one with ability, and that is controllable by the controller node, to operate using certain radio related settings out of a supported operative set of radio related settings.

### BACKGROUND

Communication devices such as wireless communication devices, that simply may be named wireless devices, may also be known as e.g. user equipments (UEs), mobile terminals, wireless terminals and/or mobile stations. A wireless device is enabled to communicate wirelessly in a wireless communication network, wireless communication system, or radio communication system, e.g. a telecommunication network, sometimes also referred to as a cellular radio system, cellular network or cellular communication system. The communication may be performed e.g. between two wireless devices, between a wireless device and a regular telephone and/or between a wireless device and a server via a Radio Access Network (RAN) and possibly one or more core networks, comprised within the cellular communication network. The wireless device may further be referred to as a mobile telephone, cellular telephone, laptop, Personal Digital Assistant (PDA), tablet computer, just to mention some further examples. Wireless devices may be so called Machine to Machine (M2M) devices or Machine Type of Communication (MTC) devices, i.e. devices that are not associated with a conventional user.

The wireless device may be, for example, portable, pocket-storable, hand-held, computer-comprised, or vehicle-mounted mobile device, enabled to communicate voice and/or data, via the RAN, with another entity, such as another wireless device or a server.

The wireless communication network may cover a geographical area which is divided into cell areas, wherein each cell area is served by at least one base station, or Base Station (BS), e.g. a Radio Base Station (RBS), which sometimes may be referred to as e.g. “eNB”, “eNodeB”, “NodeB”, “B node”, “gNB”, or BTS (Base Transceiver Station), depending on the technology and terminology used. The base stations may be of different classes such as e.g. macro eNodeB, home eNodeB or pico base station, based on transmission power and thereby also cell size. A cell is typically identified by one or more cell identities. The base station at a base station site may provide radio coverage for one or more cells. A cell is thus typically associated with a geographical area where radio coverage for that cell is provided by the base station at the base station site. Cells may overlap so that several cells cover the same geographical area. By the base station providing or serving a cell is typically meant that the base station provides radio coverage such that one or more wireless devices located in the geographical area where the radio coverage is provided may be served by the base station in said cell. When a wireless device is said to be served in or by a cell this implies that the wireless device is served by the base station providing radio coverage for the cell. Further, each base station may support one or several communication technologies. The base stations communicate over the air interface operating on radio frequencies with the wireless device within range of the base stations.

In some RANs, several base stations may be connected, e.g. by landlines or microwave, to a radio network controller, e.g. a Radio Network Controller (RNC) in Universal Mobile Telecommunication System (UMTS), and/or to each other. The radio network controller, also sometimes termed a Base Station Controller (BSC) e.g. in GSM, may supervise and coordinate various activities of the plural base stations connected thereto. GSM is an abbreviation for Global System for Mobile Communication (originally: Groupe Spécial Mobile), which may be referred to as 2nd generation or 2G.

UMTS is a third generation mobile communication system, which may be referred to as 3rd generation or 3G, and which evolved from the GSM, and provides improved mobile communication services based on Wideband Code Division Multiple Access (WCDMA) access technology. UMTS Terrestrial Radio Access Network (UTRAN) is essentially a radio access network using wideband code division multiple access for wireless devices. High Speed Packet Access (HSPA) is an amalgamation of two mobile telephony protocols, High Speed Downlink Packet Access (HSDPA) and High Speed Uplink Packet Access (HSUPA), defined by 3GPP, that extends and improves the performance of existing 3rd generation mobile telecommunication networks utilizing the WCDMA. Such networks may be named WCDMA/HSPA.

The expression downlink (DL) may be used for the transmission path from the base station to the wireless device. The expression uplink (UL) may be used for the transmission path in the opposite direction i.e. from the wireless device to the base station.

In 3rd Generation Partnership Project (3GPP) Long Term Evolution (LTE), base stations, which may be referred to as eNodeBs or eNBs, may be directly connected to other base stations and may be directly connected to one or more core networks. LTE may be referred to as 4th generation or 4G.

The 3GPP has undertaken to evolve further the UTRAN and GSM based radio access network technologies, for example into evolved UTRAN (E-UTRAN) used in LTE.

3GPP has specified and development work has continued with a fifth generation (5G) of wide area wireless communication networks, and even development with a further generation has begun.

An open RAN is a concept based on interoperability and standardization of RAN elements and is e.g. including a unified interconnection standard for white-box hardware and open source software elements from different vendors. An open RAN based architecture may e.g. integrate a modular base station software stack on “off-the-shelf” hardware which allows baseband and radio unit components from different suppliers to operate seamlessly together. This can be an alternative to conventional RAN technology that is typically provided as a hardware and software integrated platform. An ambition with open RAN has been to create a multi-supplier RAN solution that allows for separation, or disaggregation, between hardware and software with e.g. open interfaces and virtualisation, and hosting software that may control and update networks in for example the cloud. Desired benefits include supply chain diversity, solution flexibility, and new capabilities leading to increased competition and further innovation. Open RAN deployed at a network edge can benefit 5G applications such as for autonomous vehicles and the IoT, support network slicing use cases effectively, and support secure and efficient over-the-air firmware upgrades.

OpenRAN (no space) is a project group launched by the Telecom Infra Project (TIP) with an objective of defining and building e.g. 2G, 3G, and 4G RAN solutions based on general purpose, vendor neutral hardware and software defined technology.

O-RAN is an open RAN specified by the O-RAN Alliance. For example, O-RAN Alliance Working Group 4 Management Plane Specification version 7 (O-RAN.WG4.MP.0-v07.00) specifies management plane protocols used over an interface linking an O-RAN Radio Unit (O-RU) with other management plane entities, e.g. O-RAN Distributed Unit(s), O-DU(s).

One type of O-RAN Lower Layer Split (LLS) is described in O-RAN Working Group 4 Open Fronthaul specifications. Part of physical layer processing is in the O-DU and part of it is in the O-RU. In O-RAN LLS base stations, O-DU and O-RU could potentially be built by different vendors, in contrast to what typically is the case in conventional RANs where e.g. all corresponding functionality is from the same vendor. It can be realized that when different vendors are involved, provision of some functionality that easily have been or could be provided when there is only one and the same vendor may need special considerations and/or be solved in new and different ways when two different vendors are involved.

### SUMMARY

In view of the above, an object is to enable or provide one or more improvements or alternatives in relation to the prior art, such as to support or facilitate operation of O-RU(s).

According to a first aspect of embodiments herein, the object is achieved by a first method, performed by a controller node, for controlling a radio node to support energy saving by the radio node. The radio node having ability and being controllable by the controller node to operate using radio related settings according to a supported operative set of radio related settings. The controller node sends, to the radio node, a message identifying first one or more subsets of said supported operative set of radio related settings. The first one or more subsets being the only of said supported operative set that the radio node temporarily needs to be prepared to operate according to.

According to a second aspect of embodiments herein, the object is achieved by a computer program comprising instructions that when executed by one or more processors causes a controller node to perform the first method according to the first aspect.

According to a third aspect of embodiments herein, the object is achieved by a carrier comprising the computer program according to the second aspect.

According to a fourth aspect of embodiments herein, the object is achieved by a controller node for controlling a radio node to support energy saving by the radio node. The radio node having ability and being controllable by the controller node to operate using radio related settings according to a supported operative set of radio related settings. The controller node is configured to send, to the radio node, a message identifying first one or more subsets of said supported operative set of radio related settings. The first one or more subsets being the only of said supported operative set that the radio node temporarily needs to be prepared to operate according to.

According to a fifth aspect of embodiments herein, the object is achieved by a second method, performed by a radio node, for supporting energy saving by the radio node. The radio node having ability and being controllable by a controller node to operate using radio related settings according to a supported operative set of radio related settings. The radio node receives, from the controller node, a message identifying first one or more subsets of said supported operative set of radio related settings. The first one or more subsets are the only of said supported operative set that the radio node temporarily needs to be prepared to operate according to.

According to a sixth aspect of embodiments herein, the object is achieved by a computer program comprising instructions that when executed by one or more processors causes a radio node to perform the second method according to the fifth aspect.

According to a seventh aspect of embodiments herein, the object is achieved by a carrier comprising the computer program according to the sixth aspect.

According to an eighth aspect of embodiments herein, the object is achieved by a radio node for supporting energy saving by the radio node. The radio node having ability and being controllable by a controller node to operate using radio related settings according to a supported operative set of radio related settings. The radio node is configured to receive, from the controller node, a message identifying first one or more subsets of said supported operative set of radio related settings. The first one or more subsets are the only of said supported operative set that the radio node temporarily needs to be prepared to operate according to.

Thanks to embodiments herein and said message, the radio node can be informed and know that it, at least for some time, only will be controlled by the controller node to operate according to the first subset(s) of radio relates setting and that there will be certain radio related settings of the supported operative set that it thus not need to be ready to operate according to during this time. This means that the radio node, at least for some time, can operate with relaxed requirements. Embodiments herein thus offer a way for the controller node, e.g. an O-RU Controller, to via subsets as the first subset(s) inform a radio node, e.g. O-RU, about operative situations that thereby can be exploited by the radio node, e.g. by activating and/or deactivating functions, that may be proprietary, in order to reduce energy consumption. Embodiments herein thus enable introduction of proprietary energy savings features in the radio node, e.g. O-RU. The energy savings are enabled without the need to exchange, and thereby leak, implementation details between controller node and radio node, e.g. between a O-RU and a O-RU Controller. This is particularly advantageous when these are provided by non-cooperating vendors. Embodiments herein thus support and facilitate operation of the radio node, e.g. O-RU, so that it can operate with energy saving, i.e. more energy efficient.

### BRIEF DESCRIPTION OF THE DRAWINGS

Examples of embodiments herein are described in more detail with reference to the appended schematic drawings, which are briefly described in the following.

FIG. 1 is a block diagram schematically depicting a wireless communication network 100 in which embodiments herein may be implemented and utilized.

FIG. 2 is another block diagram showing communicatively connected controller and radio node(s) of embodiments herein.

FIG. 3 is a combined signalling diagram and flowchart for describing and discussing some examples and embodiments herein and related actions.

FIG. 4 is another combined signalling diagram and flowchart for illustrating some examples and embodiments in further detail.

FIG. 5 is yet another combined signalling diagram and flowchart for illustrating some examples and embodiments in further detail.

FIG. 6 is a flowchart schematically illustrating embodiments of a first method, performed by controller node, according to embodiments herein.

FIG. 7 is a schematic block diagram for illustrating embodiments of how a controller node may be configured to perform the method and actions discussed in connection with FIG. 6.

FIG. 8 is a flowchart schematically illustrating embodiments of a second method, performed by a radio node, according to embodiments herein.

FIG. 9 is a schematic block diagram for illustrating embodiments of how a radio node may be configured to perform the method and actions discussed in connection with FIG. 8.

FIG. 10 is a schematic drawing illustrating some embodiments relating to computer program(s) and carriers thereof to cause one or more network nodes to perform the method and related actions discussed in connection with FIG. 9.

### DETAILED DESCRIPTION

Throughout the following description similar reference numerals may be used to denote similar elements, units, modules, circuits, nodes, parts, items or features, when applicable. Features that appear only in some embodiments are, when embodiments are illustrated in a figure, typically indicated by dashed lines.

Embodiments herein are illustrated by exemplary embodiments. It should be noted that these embodiments are not necessarily mutually exclusive. Components from one embodiment may be tacitly assumed to be present in another embodiment and it will be obvious to a person skilled in the art how those components may be used in the other exemplary embodiments.

As part of the development of embodiments herein, the situation indicated in the Background will first be further elaborated upon.

Current O-RAN specifications, e.g. as mentioned in the Background, have limited support for energy efficiency improvement features. The O-RAN specification mentioned in the Background indicates the presence of an optional sleeping state for O-RUs and that is intended for energy savings. However, the C/U/S plane functionality is at the same time very restricted, e.g., no connectivity between UEs and O-DU, locked cell.

Moreover, in open RAN, in particular in O-RAN Lower Layer Split (O-RAN LLS), different parts, e.g. a O-DU and O-RU, may be built and be provided by different vendors. In general for open RAN, different vendors may be involved where there conventionally has been only a single vendor involved. Power savings would then depend entirely on each nodes' implementation. Limited interoperability and lack of access to certain information, that is not a problem in a conventional “single vendor” situation, may in open RAN prevent optimizations that depend on knowledge of e.g. scheduling limitations or control over PA activity. How would e.g. one implement features that require fast control of the PAs if there is no proper control interface to access implementation dependent features?

Embodiments herein aim at facilitating development of more energy efficient open RAN, and in particular O-RAN LLS, solutions, and relate to how metadata and triggers can be communicated to a O-RU for energy saving actions. Focus is on information exchange between radio node, e.g. O-RU, and a controller node, e.g. node with O-RU controller.

Embodiments herein may in general be described as communicating, from the controller to the radio node, e.g. O-RU, a subset of operative radio related settings. In some embodiments each subset corresponds to an operating mode of the radio node O-RU. Each subset is a subset of a supported, full, operative set of radio related setting of the radio node. The communicated subset contains the only of said supported operative set that the radio node needs to be prepared to operate according to during at least a certain time period. Thus the radio node also knows what it is not expected to carry out. This means that the radio node at least for a period for example can operate with relaxed requirements. Embodiments herein thus offer a way for a controller node, e.g. O-RU Controller, to via such subsets inform a radio node, e.g. O-RU, about operative situations that thereby can be exploited by the radio node, e.g. by activating and/or deactivating functions, that may be proprietary, in order to reduce energy consumption. Embodiments herein thus enable introduction of proprietary energy savings features in a radio node, e.g. O-RU, and in particular in the case of O-RAN LLS. Embodiments herein enable energy savings without the need to exchange, and thereby leak, implementation details between controller node and radio node, e.g. between a O-RU and a O-RU Controller. This is particularly advantageous since these can be provided by non-cooperating vendors.

Before discussing embodiments herein in further detail, a wireless communication network and nodes will be disclosed and in which embodiments herein may be implemented and utilized.

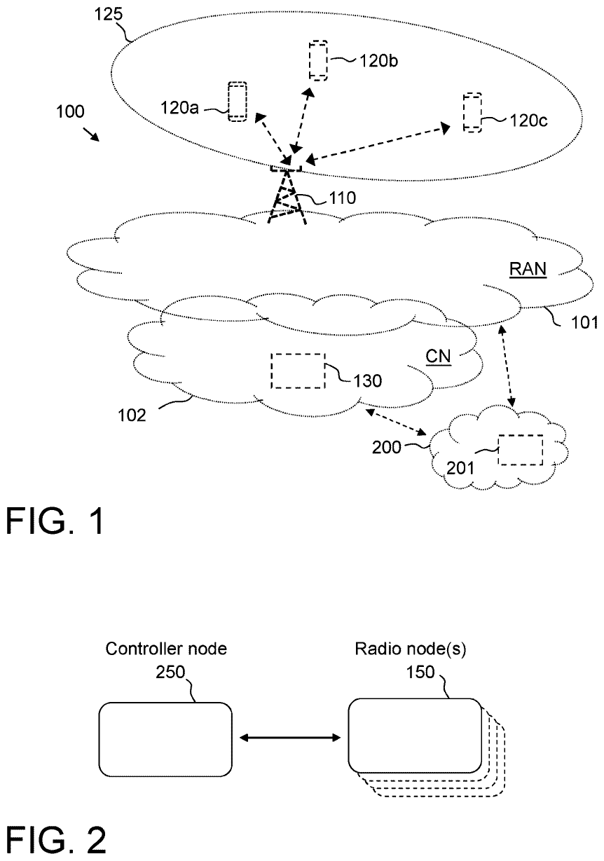

FIG. 1 is a block diagram schematically depicting a wireless communication network 100 in which embodiments herein may be implemented and utilized.

The wireless communication network 100 may comprise a Radio Access Network (RAN) 101 part and a Core Network (CN) 102 part. The wireless communication network 100 may be a telecommunication network or system, such as a cellular communication network that supports at least one Radio Access Technology (RAT), e.g. LTE, or 4G, and/or 5G, and New Radio (NR) based systems in general, including e.g. also further generations beyond 5G.

The wireless communication network 100 typically comprises network nodes that are communicatively interconnected. The network nodes may be logical and/or physical and are located in one or more physical devices. The wireless communication network 100, typically the RAN 101, comprises one or more radio network nodes, e.g. a radio network node 110 as shown in the figure. The radio network node 110, e.g. a eNB or gNB, may be or comprise radio transmitting and/or receiving device(s), such as base station(s) and/or controlling node(s) that control one or more radio transmitting and/or receiving devices. The radio network node 110 is configured to serve and/or control and/or manage one or more wireless communication devices, e.g. wireless devices 120a-120c shown in the figure. Each radio network node provides one or more radio coverages, e.g. corresponding to one or more radio coverage areas, i.e. radio coverage that enables communication with one or more wireless communication devices that it serves and/or controls and/or manages. For example, there may be a radio coverage 125 provided by the radio network node 110 for serving the wireless devices 120a-c. A wireless communication device may alternatively be named a wireless device and may correspond to a UE etc. as mentioned in the Background. Each radio coverage may be provided by and/or associated with a particular Radio Access Technology (RAT). A cell is a logical entity in which wireless devices are served through radio coverage. The radio coverage may be provided simultaneously in a relative large geographical area for serving of wireless devices in that area and/or by one or more radio beams, that simply may be named beams. As should be recognized by the skilled person, a beam is a more dynamic and relatively narrow and directional radio coverage compared to how radio coverage has been provided conventionally, and may be accomplished by so called beamforming. A beam is typically for serving one or a few communication devices at the same time, and may be specifically set up for serving one or few wireless devices. The beam may be changed dynamically by beamforming to provide desirable coverage for the one or more wireless devices being served by the beam. There may be more than one beam provided by one and the same radio network node.

Said radio network nodes may be communicatively connected, such as configured to communicate, over, or via, a certain communication interface and/or communication link with each other and/or other network nodes.

Further, the wireless communication network 100, or rather the CN 102, typically comprises one or more core network nodes. These may be communicatively connected to each other and other network nodes, such as configured to communicate, over, or via, a communication interface and/or communication link, with radio network nodes of the RAN 101, e.g. with the radio network node 110.

The wireless devices 120a-c are for communication with and via the wireless communication network 100, e.g. by being served by the wireless communication network 100 by means of one or more radio network nodes, e.g. the radio network node 110 when within its radio coverage. Radio communication between a wireless device and a radio network node of the wireless communication network typically takes part over one or more radio channels.

The figure also shows a further node 201 and a further network 200. The further node 201 may be located outside the wireless communication network 100, i.e. be an external node, as indicated in the figure, or alternatively (not indicated in the figure) be comprised in the wireless communication network 100 and thus be a network node thereof, e.g. a management node thereof. Likewise, the further network 200 may be located outside the wireless communication network 100, i.e. be an external network, as indicated in the figure, e.g. corresponding to a so-called computer cloud, often simply referred to as cloud, that may provide and/or implement services and/or functions for and/or relating to the wireless communication network 100. The further network 200 may alternatively (not indicated in the figure) be comprised in the wireless communication network 100 and thus e.g. correspond to a subnetwork thereof. It is implied that a network, e.g. an one of the wireless communication network 100 and the further network 200, comprises interconnected network nodes. The further network 200 and further node 201 may in principle be any network and network node communicatively connected to the wireless communication network, e.g. to support it in some way. The further node 201 may be comprised in the further network 200 and may then be referred to and be example of a network node of the further network 200.

The RAN 101 may, at least partly, be and/or may at least partly be implemented as, and/or may comprise, an open RAN, such as O-RAN specified by the O-RAN Alliance, and for example comprising a lower layer split (LLS), such as according to O-RAN Open Fronthaul specifications. The radio network node 110, e.g. gNB, may comprise one or more O-RUs, and in some embodiments also a O-RU Controller, while in other embodiments, another network or node comprise the O-RU Controller, e.g. the further node 201 or further network 200, e.g. a computer cloud. In these embodiments the O-RU Controller may be implemented as function in the cloud. The O-RU and O-RU Controller are further discussed below in connection with FIG. 2.

Attention is drawn to that FIG. 1 is only schematic and for exemplifying purpose and that not everything shown in the figure may be required or relevant for all embodiments herein, as should be evident to the skilled person. Also, a wireless communication network or networks that correspond(s) to the wireless communication network 100, will typically comprise several further network nodes, such as further radio network nodes, e.g. base stations, network nodes, e.g. both radio and core network nodes, etc., as realized by the skilled person, but which are not shown herein for the sake of simplifying.

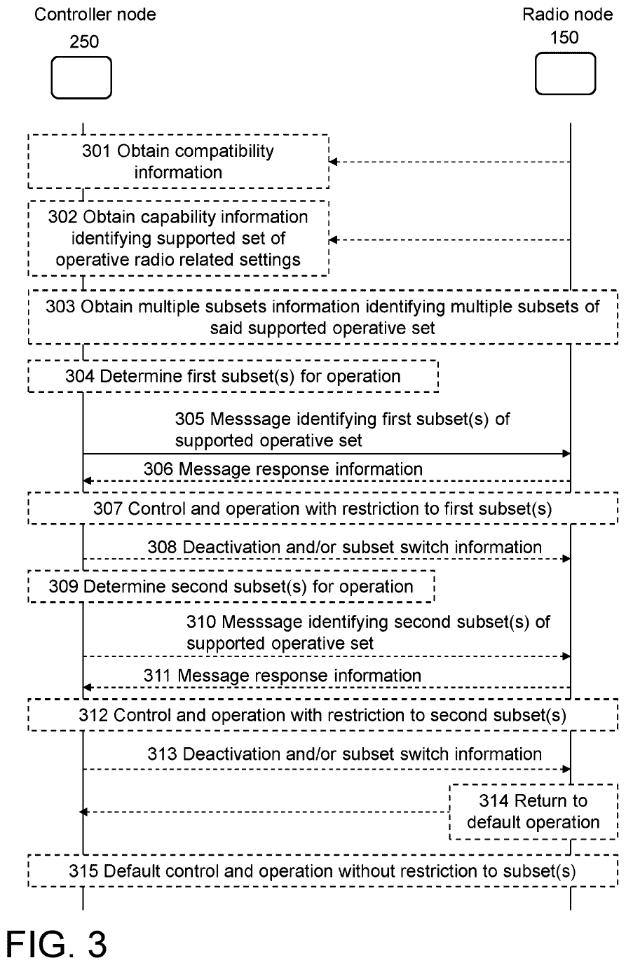

FIG. 2 is a block diagram schematically depicting one or more radio nodes 150 and a controller node 250 for controlling the radio node(s) 150. The radio node(s) 150 and controller node 250 may be according to embodiments herein, as described in further detail below. The controller node 250 and the radio node(s) 150 are communicatively connected. The radio node(s) 150 should have ability and be controllable by the controller node 250 to operate using radio related settings from a supported operative set of radio related settings, i.e. a set with radio related settings that the radio node(s) 150 supports and can operate according to and can be controlled by the controller node 250 to operate according to. The supported operative set of radio related settings and subsets thereof are separately discussed and exemplified further below, at the end of the text describing FIG. 3.

In some embodiments, the radio node 150 comprises or corresponds to a O-RU Controller and the radio node(s) 150 comprises or corresponds to O-RU(s). The radio node(s) 150 may be logical and/or physical nodes. In the latter case the O-RU(s) may be comprised in or correspond to a radio network node, such as the radio network node 110, e.g. a gNB. The controller node 250 may also be a logical and/or physical node. In the latter case the controller node 250 may be comprised in a radio network node, such as the radio network node 110, e.g. a gNB, or in another physical node of a wireless communication network, e.g. the wireless communication network 100, e.g. in a RAN or CN thereof, e.g. the RAN 101 or CN 102, or may be comprised in, such as implemented in, a server or computer cloud, e.g. corresponding to the further network 200 and/or further network node 201. For example, in some embodiments, the radio node 150 corresponds to an O-RU and is comprised in the radio network node 110, e.g. a gNB and the controller node 250 corresponds to an O-RU controller and is comprised, or implemented, in a computer cloud, e.g. as a function and/or service provided by the cloud.

FIG. 3 is a combined signalling diagram and flowchart for describing and discussing some examples and embodiments herein, and related actions. The actions in the following and as illustrated in the figure and example are performed by one of the radio node(s) 150, in the following referred to as the radio node 150, and the controller node 250. The radio node(s) 150 is thus a radio node that has ability and is controllable by the controller node 250 to operate using radio related settings from a supported operative set of radio related settings, i.e. a set with radio related settings that the radio node(s) 150 supports and can operate according to and can be controlled by the controller node 250 to operate according to. The supported operative set of radio related settings and subsets thereof are separately discussed and exemplified further below, at the end of the text describing FIG. 3.

The actions below may be part of a method for controlling the radio node 150 and may be taken in any suitable order and/or be carried out fully or partly overlapping in time when this is possible and suitable.

### Action 301

The controller node 250 may obtain compatibility information, indicating that the radio node 150 supports a certain message type (as used for the message in Action 305 and Action 310 below) and thus can operate based on messages of this type. The message and message type may be for energy saving purpose and/or operation and in that case the compatibility information may indicate that the radio node 150 supports said message type and energy saving operation based on messages of said message type.

This can make sure that the controller node 250 does not attempt to send such message to a radio node that cannot act upon it as intended.

In some embodiments the compatibility information is sent by the radio node 150 and is obtained by being received by the controller node 250. In other embodiments the controller node 250 may obtain the compatibility information from a management node or similar that keeps track of which radio nodes that support such messages and operation based on them.

### Action 302

The controller node 250 may obtain capability information identifying said supported operative set of radio related settings, i.e. the set with radio related settings that the radio node(s) 150 supports and can operate according to.

In some embodiments, the capability information is obtained by being received from the radio node 150. In other embodiments the controller node 250 may obtain the capability information from a management node or similar that keeps track of what capabilities radio nodes have.

### Action 303

The controller node 250 may obtain multiple subsets information identifying multiple subsets of said supported operative set.

In some embodiments, the radio node 150 sends said multiple subsets information to the controller node 250 that receives it. In some embodiments, the multiple subsets information is sent with, e.g. comprised in, the capability information. In some embodiments the capability information identifies said supported operative set by identifying said multiple subsets. The union of the multiple subsets may in these embodiments correspond to the supported operative set identified by the capability information. In some embodiments, where the controller node 250 receives multiple subsets information from the radio node 150, the controller node 250 configures new subset(s) based on the multiple subsets identified by the multiple subsets information from the radio node 150 and informs the radio node 150 about the configured new subsets.

In other embodiments, said multiple subsets information is obtained by being configured by the controller node 250 based on the obtained capability information. In these embodiments, the controller node 250 may thus determine the multiple subsets, alone or in communication with the radio node 150. When the multiple subsets have been configured, if not before, the radio node 150 should be informed about the configured multiple subsets, so that the controller node 250 and the radio node 150 are aware of the same multiple subsets.

Use of multiple subsets as above, that both the controller node 250 and the radio node 150 are aware of, can facilitate and reduce further communication, where it e.g. can sufficient to e.g. refer to a single of the multiple subsets instead of having to refer to all radio related settings thereof.

Respective subset, above and in the following, may correspond to a respective, operating mode of the radio node 150, at least one thereof being energy saving, or at least potentially energy saving. In respective operating mode the radio node may have ability to operate more energy efficient if, and/or based on that, it only needs to be prepared for operating according to the radio related settings of the subset.

### Action 304

The controller node 250 may determine first one or more subsets, typically one subset, from said supported operative set based on what radio related settings are temporarily sufficient for operation by the radio node 150. For example if or when the controller node 250 knows that the controller node 250 for a period to come can and will not require the radio node to use any other radio related settings than according the first subset(s). The first one or more subsets should thus be the only of said supported operative set that the radio node 150 temporarily shall needs to be prepared to operate according to.

### Action 305

The controller node 250 sends, to the radio node 150, that receives, a message identifying first one or more subsets of said supported operative set of radio related settings, such as the first subsets(s) determined in Action 304. The first one or more subsets being the only of said supported operative set that the radio node 150 temporarily needs to be prepared to operate according to.

In embodiments where the controller node 250, as in Action 303, obtains the multiple subsets information, said first one or more subsets identified by the message may be identified based on said multiple subsets.

### Action 306

The radio node may, in response to receipt of the message in Action 305, send, to the controller node 250 that may receive, message response information. The message response information indicates one or more of the following: acknowledgement of receipt of the message, that the radio node 150, and/or how long the radio node 150, will be prepared to, or can, operate only according to said first one or more subsets identified by the message.

It may be implicit what this acknowledgement of the received message means, or it may be explicitly signaled in the message response information, for example that the radio node will be prepared to operate only according to said first one or more subsets identified by the message until further notice, such as until instructed otherwise by the controller node 250, e.g. until receiving another message identifying second subset(s) that replaces the first subset(s), and/or according to receipt of deactivation and/or subset switch information as discussed separately below. In some embodiments, the radio node 150 determines how long the radio node 150 will be prepared to, or can, operate only according to said first one or more subsets identified by the message. There may e.g. be reason for the radio node 150 to apply said first subset(s) for a shorter period or not at all, and this may be valuable information to signal to the controller node 250 since in that situation there may be no need nor gain to restrict control of the radio node 150 based on the first subset(s), i.e. so that the radio node 150 can operate limited to the first subset(s) of radio related settings. The controller node 250 can instead e.g. try to determine a second subset(s) that may be more suitable.

### Action 307

The radio node 150 may be controlled by the controller node 250 to only operate according to the first subset(s) as identified by said message, i.e. only having to use radio related settings of the first subset(s). In embodiments where the first subset(s) corresponds to operating mode(s) of the radio node 150, e.g. energy saving operating modes, the radio node 150 may in this action thus switch to and operate according to this operating mode using radio related setting of the first subset(s) and e.g. switching off some functionalities, setting support etc. that the radio node 150 knows it will not be controlled to operate according to thanks to the message and the knowledge of the first subset(s).

### Action 308

The controller node 250 may send, to the radio node 150 that may receive deactivation and/or subset switch information. This information may indicate when said first one or more subsets identified by the message no longer apply as the only of said supported operative set that the radio node 150 needs to be prepared to operate according to. In other words, the deactivation and/or subset switch information indicates when there is or will be deactivation of operation based on the first subset(s).

In some embodiments, the deactivation and/or subset switch information indicates when another message, identifying second one or more subsets of said supported operative set of radio related settings, can be expected, and/or when second one or more subsets of said supported operative set of radio related settings apply. When these apply said second one or more subsets will instead be the only of said supported operative set that the radio node 150 temporarily needs to be prepared to operate according, i.e. instead of the first one or more subsets.

In some embodiments, there is a switch from the first subset(s) to the second subset(s) and this determines when the first subset(s) no longer apply, i.e. is deactivated.

In other embodiments the deactivation and/or subset switch information informs about when the first subset(s) no longer apply but without indicating something about a second subset(s) that applies instead.

In both cases, i.e. in case of only indication of deactivation, or deactivation by application of a second subset(s), this may apply directly upon receipt of the deactivation and/or subset switch information, or after a certain, e.g. predetermined, time thereafter, or at a certain point in time that need not be determined in relation to the time of receipt of the deactivation and/or subset switch information. Said certain point in time may be determined by time out of a first time period, or may correspond to a specific point in time according to a clock, and/or be based on a certain trigger event, e.g. upon receipt of a deactivation signal or a new message, directly upon such trigger event or a second time period thereafter. Said certain point, first time period and/or second time period may be predetermined, predefined and/or be identified by, e.g. comprised in, the deactivation and/or subset switch information. Said first time period and/or second time period may be specified by and/or with reference to multiples of some quantity associated with time, such as a symbol or slot duration.

In some embodiments, the deactivation and/or subset switch information is/are sent with, e.g. be comprised in, said message, e.g. the message of Action 305.

In case no other, e.g. second, subset(s), will apply instead of the first subsets(s) when it no longer apply, the radio node may switch to, e.g. return to default operation where it is prepared to be controlled to operate according to any of the settings according to the supported operative set of radio related settings, see also Action 314 below.

### Action 309

At some point in time, the controller node 250 may determine another, second one or more subsets, typically one subset, from said supported operative set based on what radio related settings are temporarily sufficient for operation by the radio node 150, i.e. for control and operation of the radio node 150. The controller node 250 may be triggered to perform the present action by that a temporal period during which the first subset(s) apply is about to end and/or by that the controller node 250 finds out that the radio node 150 will need to be controlled to apply radio related setting that are not part of, and/or not supported by, the first subset(s). The trigger here may be a same kind of trigger that triggers Action 304, i.e. determination of the first subset(s).

The present action may thus correspond to Action 304 but where the result is the second subset(s).

The controller node 250 may in the present action, in some situations, happen to determine the same subset, e.g. the first subset(s), i.e. come to conclusion it can continue to be applied temporarily, but for another time period, resulting in an extension of how long the already applied first subset(s) will be applied. When this happens, the second subset(s) and the first subset(s) are thus the same.

### Actions 310-313

These actions may correspond to Actions 305-308, mutatis mutandis, i.e. with the second subset(s) instead of the first subset(s) etc. For example, Action 312 thus involves that the radio node 150 may switch from an operating mode based on the first subset(s) to an operating mode based on the second subset(s).

### Action 314

In some embodiments, already indicated above, the radio node 150 may return to default operation. This may e.g. happen when a time period for temporary application of the first subset(s) times out and there is no second subset(s) that applies instead. The radio node 150 may in the present action thus switch to, e.g. return to, default operation where it is prepared to be controlled to operate according to any of the settings according to the supported operative set of radio related settings.

In some embodiments, returning to default operation corresponds to the that radio node 150 leaves an energy saving mode.

In some of these embodiments, the radio node 150 signals to the controller node 250 that it has or will return to default operation.

### Action 315

After having returned to default operation the radio 150 may be controlled by the controller node 250 and operate correspondingly as in a case without embodiments herein, and without any restriction to subset(s) as described herein being involved.

Said supported operative set of radio related setting may be within several different radio related areas, and wherein respective subset of settings may be within one or more of these radio related areas and may, in respective area, comprise a subset of all supported settings in that area.

### For Example

The radio related areas may be one or more of the following:
modulation,
carrier bandwidth,
transmission power,
transmission mode,
transmission time,
transmission duration,
MIMO schemes,
type and/or number of antennas,
precoding schemes,
detection schemes,
digital signaling and/or processing algorithms,
signal quality.

Digital processing algorithm refers to an algorithm that is not necessarily involving signalling, such as protocol level communication, to another node, apart from any reception and/or transmission of digitized signals that the digital processing algorithm itself operates on and provides. A digital processing algorithm may e.g. relate to digital filtering.

Signal quality may here, for example, relate to one or more of the following: max Error Vector Magnitude (EVM), unwanted emission level, noise figure, phase noise etc.

The supported operative set of radio related settings in said radio related areas may be or correspond to one or more of the following:
all operatively supported types of modulations,
all operatively supported carrier bandwidths,
the operatively supported maximum and/or all operatively supported ranges of transmission power,
all operatively supported transmission modes,
all operatively supported transmission time slots,
all operatively supported signal quality related settings,
all supported MIMO schemes,
all operatively supported antenna types and/or number of antennas,
all operatively supported precoding schemes,
all operatively supported detection schemes,
all operatively supported digital signaling algorithms,
all operatively supported signal quality settings.

The subsets of settings within the radio related areas may each correspond to and/or relate to one or more of the following:
part of all operatively supported types of modulations,
part of all operatively supported carrier bandwidths,
part of the operatively supported maximum transmission power,
part of the operatively supported ranges of transmission power,
part of all operatively supported transmission modes,
part of all operatively supported transmission time slots,
some of all operatively supported signal quality related settings,
part of all supported MIMO schemes,
part of all operatively supported antenna types
part of the operatively supported number of antennas
part of all operatively supported precoding schemes
part of all operatively supported detection schemes,
part of all operatively supported digital signaling algorithms.
part of all operatively supported signal quality settings.

It should be noted that above and herein, the subsets may be different to DL and UL operation, for example, UL and DL subsets may be separate.

As used herein and in the context of the foregoing paragraphs, “part” and “some” refers to one or several but not all.

As explained, above, in some embodiments the subsets correspond to modes and a subset may then be referred to as a mode. A radio node, or O-RU, subset, and radio node, or O-RU, mode may in some embodiments both refer to such subset as discussed above, for operation by the radio node.

The radio related settings of a subset, or mode, may inform the radio node 150, e.g. O-RU, that it, as long the subset is valid, the radio node 150 is only for example expected to:
i. carry out certain quadrature amplitude modulation (QAM), such as 4QAM and 16QAM, and consequently not e.g. 64QAM and 256QAM, and/or
ii. operate on a portion or fraction of the total carrier bandwidth (e.g. a fraction of the totally available Physical Resource Blocks, PRBs), and/or
iii. use a fraction of the total available transmission power, and/or
iv. operate on a subset of the possible transmission modes (e.g., reduced MIMO processing), and/or
v. serve traffic with a reduced peak rate in UL and/or DL, and/or
vi. transmit in the third slot of a cell configured with a specific slot format sequence, e.g. “DDDSU”, and/or
vii. transmit and or receive in a given time interval, set of time intervals or according to some periodicity, and/or
viii. not transmit and or receive in a given frequency interval, set of frequency intervals or according to some periodicity, and/or
ix. process data for a limited number of wireless devices, e.g. UEs, such as one or two, in each transmission time interval (TTI),
etc.

A subset, or mode, may thus correspond to one or several bullets of the above list. If it e.g. correspond to bullet i.) regarding modulation, the subset will consequently correspond to a subset of constellation orders that the O-RU is expected to operate with.

It should be clear, at least to the skilled person, that subsets as exemplified above allow the radio nod 150 to save energy by, for example by:
reducing the bit resolution in its analog-to-digital converters (ADCs) when the constellation order is restricted, and/or
reducing a power backoff setting in power amplifiers, and/or
using a simple, or no, digital pre-distortion (DPD) algorithm and/or a simple, or no, peak-to-average power ratio (PAPR) reduction algorithm that requires less digital processing, and/or
reducing the voltage and/or clock speed of digital processors to reduce leakage and switching losses in digital circuits, such as dynamic voltage and frequency scaling, dynamic voltage and frequency scaling (DVFS), and/or
reducing the link rate of, or temporarily halting, digital interfaces, for example Sony/Philips Digital Interconnect Format (SPDIF), optical transceivers, Ethernet etc., to enable lower power consumption;
etc.

After explicitly or implicitly having been informed through said message and subset(s), or mode(s), the radio node 150 may operate energy saving based on such subset(s), or mode that corresponds to one of the subsets. The controller node 250, e.g. a paired O-RU controller, then for example restricts its grant and/or assignment characteristics such as to conform to the operating characteristics of the radio node 150 in the energy saving mode. For example, the controller node 250 may instruct the radio node 150 that it is not expected to carry 256QAM in DL and then proceed to limit its assignments to at most 64QAM while the energy saving mode is active.

As realized from above, a total of available or possible subsets to use, and corresponding modes, may fully or partly be predefined or predetermined, e.g. defined in a standard, manual or the like. For example in embodiments with multiple subsets as discussed above under Action 303. The radio node 150 and/or controller node 250, depending on which is involved in providing and/or defining the subsets, or modes, may then select from subsets that are predefined or predetermined. In some embodiments, some subsets are predefined or predetermined, but others may be provided and/or be defined by the radio node 150 and/or controller node 250. In some embodiments, when predefined and/or predetermined subsets are possible and/or available to use, these may be prioritized to use before other.

A first example: Assume there are two different subsets, corresponding to operating modes of the radio node 150, and relating to constellation orders, that are predefined as:
QAM Mode 1: 4QAM and 16QAM
QAM Mode 2: 4QAM, 16QAM, 64QAM, 256QAM

These may thus e.g. be predefined in and defined by a standard or manual. The modes may also be signaled from the radio node 150, e.g. O-RU, to the controller node 250, e.g. O-RU Controller, for example as part of Action 302 and/or 303.

Another example: A subset, supplement or alternative to predefined subsets as in the first example, may instead be configured by the radio node 150 and/or controller node 250, e.g. as discussed in relation to Action 303. Assume the subset is named QAM mode 1, corresponding to an operating mode regarding modulation, it may e.g. be configured as QAM Mode 1: 4QAM or QAM Mode 1: 4QAM and 16QAM.

In some embodiments there are a certain number of subsets, and/or modes, available and that may be predetermined, e.g. a fixed available number, some may be with predefined or predetermined settings and some configurable. For example, subsets or modes numbered 1-16, where some of the numbered subsets have predefined or predetermined settings as above and other are configurable, or that all are predefined or predetermined, or all configurable. An advantage with this is that a specific subset can be referred to by a single number and messaging can be more efficient.

Subsets, e.g. corresponding to modes, can be indicted and signalled in various ways. Most efficient may be via a number, e.g. via a number of bits that may be allocated for this. In the example of just two subsets, or modes, QAM Mode 1 and QAM Mode 2 as above, a single bit may be used to indicate either mode, e.g., a ‘0’ representing QAM Mode 1 and ‘1’ representing QAM Mode 2. In case of O-RAN, where the radio node 150 is a O-RU and the controller node 250 is a O-RU Controller, a subset, or corresponding mode, may be verified and edited with NETCONF remote procedure calls as provided by the O-RAN M-Plane specification, see O-RAN Alliance Working Group 4 Management Plane Specification version 7 (O-RAN.WG4.MP.0-v07.00), pages 62-70, and Network Configuration Protocol (NETCONF) IETF RFC 624, pages 13-19, 35-68.

In some embodiments, the radio node 150 signals to the controller node which subsets, or corresponding modes, it supports, e.g. as discussed above for Actions 302 and 303. The radio node 150 may for instance signal that it can operate using QAM Mode 1 but not QAM Mode 2, using the same examples as above. In case of O-RAN, where the radio node 150 is a O-RU and the controller node 250 is a O-RU Controller the signaling may be based on so called YANG/NETCONF messages as provided by the O-RAN M-Plane specification, see O-RAN Alliance Working Group 4 Management Plane Specification version 7 (O-RAN.WG4.MP.0-v07.00), pages 62-70, and The YANG 1.1 Data Modeling Language—IETF 7950, pages 44-136.

In some embodiments, the default operation mentioned above may correspond, or rather map, to a certain operating mode similarly as for subsets as well, although in this case this operating mode is not corresponding to a specific subset but to all radio related settings that the radio node(s) 150 supports and can be controlled by the controller node 250 to operate according to. Reason to still map default operation to a mode may be to be able to handle it in a similar manner as the subsets and modes corresponding to subsets. For example assign default operation to a certain “mode identifying” number as mentioned above, e.g. such that a number 0, for example represented by bits '000 when a total number of different modes are 8, corresponds to default operation, while higher numbers map to different subsets, respectively.

Independent on how the subsets or corresponding modes as such are identified, e.g. by numbers as discussed above or other identification, switching to/from operation according to one subset or mode to another can be accomplished in different ways, as already indicated in relation to FIG. 3. For example to switch to/from default operation with all supported radio related settings from/to operation according to mode that corresponds to a subset of the radio related settings, or switch between different subsets or modes.

In some embodiments it is always the same type of switching, for example there is only one supported way of how the switching is made. In some other embodiments different type of switching is supported and in these embodiments signaling of how to perform the switching can be utilized. As already indicated above in relation to Action 308, such signaling may be separate from and/or be sent with, e.g. comprised in, the message identifying the subset(s), such as in Action 305. In any case, one or more of the following types of switching may for example be supported:

### Permanent Switch:

The radio node 150 switches from operation according to a first subset to operation according to a second subset and operate according to this until further notice, e.g. until it is informed, e.g. messaged, about a new subset to operate according to.

### Semi-Persistent Switch:

The radio node 150 switches from operation according to a first subset to operation according to a second subset and operate according to this until the controller node 250 signals to the radio node 150 that the switch, i.e. operation according to the first subset, is no longer applicable, and the radio node 150 may then switch to default operation.

### Temporary Switch:

The radio node 150 switches from operation according to a first subset to operation according to a second subset and operate according to this for a limited time that is predefined or predetermined, i.e. applies the switch for specific time period. Thereafter the radio node 150 switches to default operation.

### Periodic Temporary Switch:

The radio node 150 switches from operation according to a first subset to operation according to a second subset and operate according to this for a limited time and switch to default operation, e.g. as for the temporary switch, and then this is repeated with some periodicity. Even though this may mean that the radio node switch back and forth to the same, here second, subset, or extends the time for operation according to this subset, this may be a preferred way when the controller node only can guarantee restriction to a subset for a limited time each time it determines the subset to be suitable for use.

In general, there may be some delays involved when switching from one mode of operation to another, e.g. operation according to one subset to another. The radio node controller 250 may need to know how long it takes until the radio node 150 is ready for operation according to a subset, or that it is informed when the switch has occurred. Both cases have already been discussed in the foregoing. In some embodiments the transition time or times to switch between supported subsets, or corresponding modes, is/are predetermined and e.g. listed in a standard specification, and/or the time for switching is signaled from the radio node 150 to the controller node 250.

In other embodiments there is a maximum switch transition time that may be predetermined, and e.g. listed in a standard specification, which transition time the radio node 150 is needed to comply with to be considered compatible and supportive of embodiments herein, and/or that is required for a subset, or corresponding mode, to be considered supported by the radio node 150. In some embodiments, different modes and/or switching directions may be associated with different switching times. For example, a first subset corresponding to a low capability and high energy saving mode may have longer acceptable switching time to a second subset corresponding to a higher capability mode, than vice versa, i.e. compared to switching in the opposite direction.

In some embodiments, the controller node 250 is aware of actual power consumption in each radio node it controls, e.g. the radio node 150. In any case, if subsets corresponding to lower power modes are defined, it my suffice that such lower power node has less or equal power consumption than a another mode for the same traffic, the latter thus being a higher power mode in relation to the lower power node. It may be predefined or predetermined, and e.g. listed in a standard specification, a minimum power saving, such in relation to a higher supported mode of default operation, that must be achieved to consider a mode to be a low, or lower power, mode and be supported by the radio node 150.

In some embodiments, the controller node 250 signals “side information” to the radio node 150 and that e.g. informs the radio node 150 of a time interval where it can expect that a subset, or mode, switch will occur, or will not occur. The side information may corresponds to or be comprised in the “deactivation an/or subset switch” information discussed above in relation to Action 308. The information may for example contain information like “the radio node will be requested to switch subset to operate according to during a certain time period, e.g. during the next X seconds”, “the radio node will not need to switch subset to operate according to during a certain time period, e.g. for the next 5 seconds”, “the radio node will be notified at least a certain time, e.g. at least 5 seconds, before it is expected to switch subset to operate according to”

The “side information”, e.g. the “deactivation and/or subset switch information” discussed in relation to FIG. 3 may additionally or alternatively contain relative timing information, e.g. indicating the start of a period or interval relative to a timing reference, e.g. frame number.

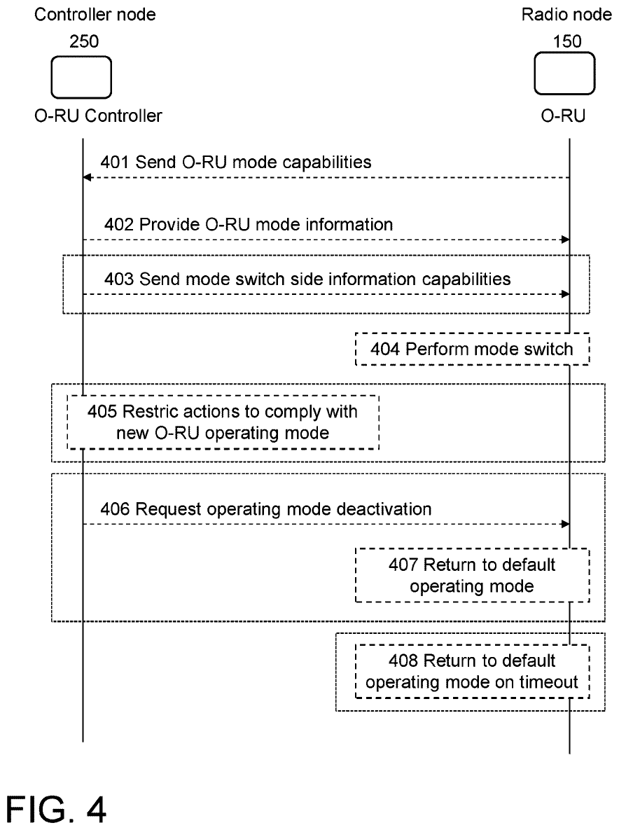

FIG. 4 is another combined signaling diagram and flowchart for illustrating some examples and embodiments indicated above in further detail. In the shown example the controller node 250 is exemplified as a O-RU Controller and the radio node 150 is exemplified as a O-RU.

In the shown example the mode(s) corresponds to subset(s) as discussed above.

The actions may be taken in any suitable order and/or be carried out fully or partly overlapping in time when this is possible and suitable.

### Action 401

The radio node 150 may send information on mode capabilities to the controller node 250 that receives this information.

The present action may fully or partly correspond to Action 302.

### Action 402

The controller mode 250 may send mode information, i.e. information on mode(s), to the radio node 150 that receives this information.

The present action may fully or partly correspond to Action 305 above, i.e. the mode information comprises information as in the message of Action 305, i.e. identifies first one or more subset(s) of the supported operative set of radio related settings, where each subset in the example of FIG. 4 is identified by the mode that the subset corresponds to.

### Action 403

The controller node 250 may send side information regarding mode switch, e.g. such side information as discussed above.

The present action may fully or partly correspond to Action 308 and/or Action 313.

### Action 404

The radio node 150 may perform mode switch based on the information received in Action 402, which mode is based on that the radio node 150 can expect to only be controlled to operate using radio related setting according to the subset that the mode corresponds to. The switch may also be based on the information received in Action 403.

The present action may fully or partly correspond to Action 307 and/or Action 312.

### Action 405

The controller mode 250 should restrict control of the radio node so that it will be controlled to only operate using radio related setting based on the subset that corresponds to the mode it switched to.

The present action may fully or partly correspond to Action 307 and/or Action 312.

### Action 406

The controller mode 250 may send a request for deactivation of the operating mode to the radio node 150 that receives this request. That is, deactivation of the mode that the radio node 150 operates according to and that correspond to said subset, and/or the request may simply request that the radio node 150 switches to default operation and thus should be ready to be controlled to operate according to any radio related setting it supports, not just according to the subset.

The present action may fully or partly correspond to Action 308 and/or Action 313.

### Action 407

In response to Action 406, the radio node 150 may thus return to default operation.

The present action may fully or partly correspond to Action 314.

### Action 408

The radio node 150, for example alternatively or additionally to Actions 406-407, may return to default operation on timeout that may be based on any of the examples discussed above.

The present action may fully or partly correspond to Action 314.

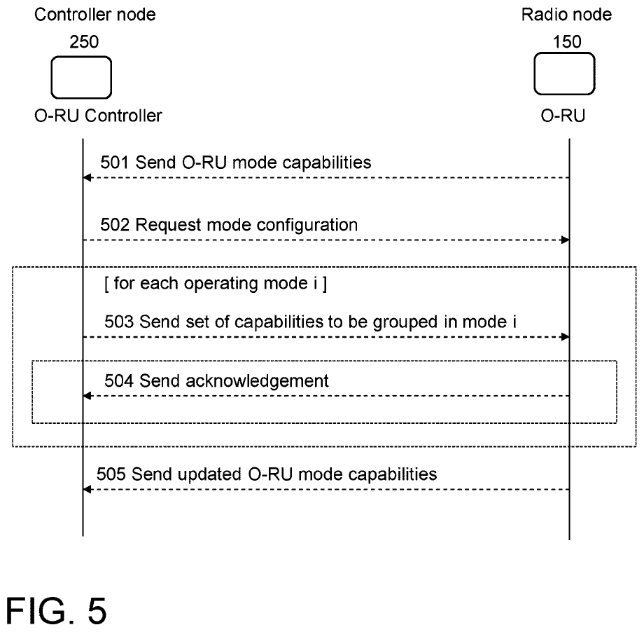

FIG. 5 is yet another combined signaling diagram and flowchart for illustrating some examples and embodiments indicated above in further detail, in particularly embodiments relating to exchange of capabilities. In the shown example the controller node 250 is exemplified as a O-RU Controller and the radio node 150 is exemplified as a O-RU.

In the shown example the mode(s) corresponds to subset(s) as discussed above.

The actions may be taken in any suitable order and/or be carried out fully or partly overlapping in time when this is possible and suitable.

### Action 501

The radio node 150 may send information on mode capabilities to the controller node 250 that receives this information. That is, the controller node knows from this action about a set or radio related setting that the radio node 150 supports and can be controlled to operate according to, and even more specifically the controller node 250 may know about operating modes that the radio node 150 can operate according to and that corresponds to the subsets.

The present action may fully or partly correspond to Action 302 or Action 401.

### Action 502

The controller node 250 may send a request for mode configuration to the radio node 150 that receives this request.

The present action may fully or partly correspond to Action 303.

### Action 503

The controller node 250 may send, as a proposal or request, radio related settings to be comprised, i.e. grouped, in a subset and to correspond to an operating mode of the radio node 150. If there is certain number of modes available, this may be done for all or some of these modes.

The present action may fully or partly correspond to Action 303.

### Action 504

The radio node 150 may, e.g. per subset and mode, acknowledge the proposal or request made in Acton 503, and e.g. accept or reject the proposal or request. In case of rejections, the controller node may send another request or proposal with another subset.

The present action may fully or partly correspond to Action 303.

It may be realized that based on Actions 503-504 the controller node 250 and the radio node 150, through communication and/or negotiation with each other, can agree on subsets corresponding to operating modes of the radio node 150 that will be working and be acceptable for both the controller node and the radio node 150.

### Action 505

The radio node 150 may send information on update mode capabilities to the controller mode 250. For example subsets is supports and/or operating modes corresponding to such subsets. These may result from Actions 503-504 and/or be subsets or operating modes the radio node 150 knows it supports for other reasons, e.g. as indicated elsewhere herein.

The present action may fully or partly correspond to Action 303.

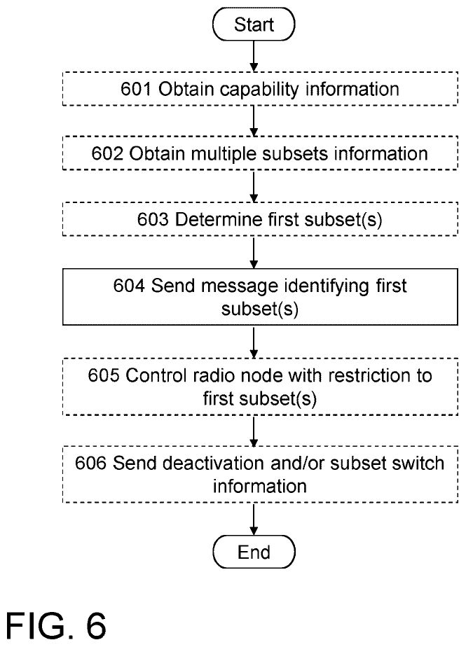

FIG. 6 is a flowchart schematically illustrating embodiments of a first method, performed by a controller node, according to embodiments herein and based on the above discussed examples and embodiments. The method is for controlling a radio node to support energy saving by the radio node. The radio node has ability and is controllable by the controller node to operate using radio related settings according to a supported operative set of radio related settings. In the following said controller node is exemplified by the controller node 250 and said radio node is exemplified by the radio node 150.

The actions below that may form the method may be taken in any suitable order and/or be carried out fully or partly overlapping in time when this is possible and suitable.

### Action 601

The controller node 250 may obtain capability information identifying said supported operative set.

In some embodiments, the capability information is obtained by being received from the radio node 150.

This action may fully or partly correspond to one or more of Actions 302, 401, 501.

### Action 602

The controller node 250 may obtain multiple subsets information identifying multiple subsets of said supported operative set.

In some embodiments, said multiple subsets information is obtained by being received from the radio node 150. In some of these embodiments, the controller node 250 configures new subset(s) based on the multiple subsets information received from the radio node 150, and the radio node 150 is informed about the configured new subsets.

In some embodiments, said multiple subsets information is obtained by being configured by the controller node 250 based on the obtained capability information, and wherein the radio node is informed about the configured multiple subsets, e.g. by that the controller node 250 sends said configured multiple subsets information to the radio node 150.

This action may fully or partly correspond to one or more of Actions 303, 401, 501-505.

### Action 603

The controller node 250 may determine said first one or more subsets from said supported operative set based on what radio related settings are temporarily sufficient for operation by the radio node 150.

This action may fully or partly correspond to one or more of Actions 304 and actions performed by the controller node 250 between Actions 401-402.

### Action 604

The controller node 250 sends, to the radio node 150, a message identifying first one or more subsets of said supported operative set of radio related settings. Said first one or more subsets being identified as the only of said supported operative set that the radio node 150 temporarily needs to be prepared to operate according to.

In embodiments where multiple subsets information is obtained as in Action 602, said first one or more subsets may be identified by the message based on said multiple subsets.

This action may fully or partly correspond to one or more of Actions 305, 402.

### Action 605

The controller node 250 may control the radio node 150 with temporary restriction to said first one or more subsets in accordance with the sent message.

This action may fully or partly correspond to one or more of Actions 307, 405.

### Action 606

The controller node 250 may send, to the radio node 150, deactivation and/or subset switch information indicating when said first one or more subsets identified by the message no longer apply as the only of said supported operative set that the radio node 150 needs to be prepared to operate according to.

In some embodiments, the deactivation and/or subset switch information indicates:
when another message, identifying second one or more subsets of said supported operative set of radio related settings, can be expected, and/or
when second one or more subsets of said supported operative set of radio related settings apply, whereafter said second one or more subsets will be the only of said supported operative set that the radio node 150 temporarily needs to be prepared to operate according to.

This action may fully or partly correspond to one or more of Actions 308, 406.

In some embodiments, respective subset corresponds to an operating mode of the radio node 150.

Said supported operative set may be within several different radio related areas. Respective subset of settings may then be within one or more of these radio related areas and in respective area comprise a subset of all supported settings in that area.

In some embodiments, the radio node 150 is an O-RAN Radio Unit, O-RU, and the controller node 250 is an O-RU Controller.

In some embodiments, the radio node 150 is comprised in a radio network node, e.g. the radio network node 110, of a wireless communication network, e.g. the wireless communication network 100. The radio network node being configured to serve one or more wireless communication devices, e.g. the wireless communication devices 120a-c. In some of these embodiments, the controller node 250 is comprised in the radio network node or in a further network, e.g. the further network 200, and/or further network node, e.g. the further network node 201. The controller node 250 may e.g. be implemented as a cloud service provided by the further network and/or further network node.

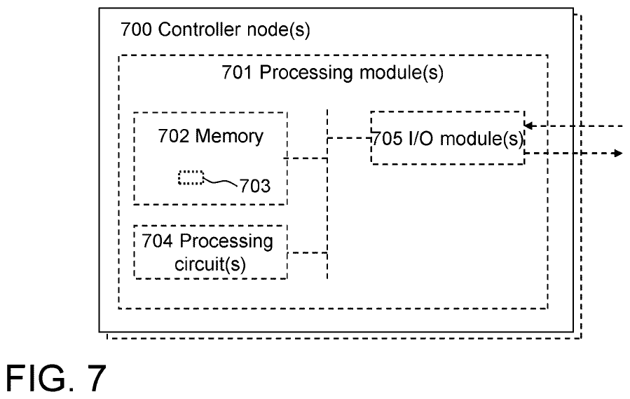

FIG. 7 is a schematic block diagram for illustrating embodiments of how one or more controller nodes, e.g. devices, 700 may be configured to perform the method and actions discussed in connection with FIG. 6. The controller node(s) 700 may be physical node(s) that correspond to or comprises the controller node 250. As already indicated above for the controller node 250, in some embodiments, the controller node(s) 700 may be or correspond to a radio network node, e.g. the radio network node 110, of a wireless communication network, e.g. the wireless communication network 100. The radio network node being configured to serve one or more wireless communication devices, e.g. the wireless communication devices 120a-c. In some embodiments, the controller node(s) 700 is or corresponds to a further network, e.g. the further network 200, thus with several network nodes that may be involved, and/or is or corresponds to a further network node, such as a server, e.g. the further network node 201. This may be the case in embodiments where the controller node 250 is implemented as service provided by a server or cloud, as a so called cloud service.

In embodiments where the controller node 250 is a logical node, what is disclosed in relation to FIG. 7 may relate to how the controller node(s) 700 may be configured to make the controller node 250 perform the method and actions discussed in connection with FIG. 6. In order to facilitate relating what is being described below to what has already been described above in relation to FIG. 6, the controller node 250 may be used to exemplify the controller node(s) 700, i.e. they may be used interchangeably.

Hence, the controller node(s) 700 is for controlling the radio node 150 to support energy saving by the radio node 150, the radio node 150 having ability and being controllable by the controller node(s) 700 to operate using said radio related settings according to said supported operative set of radio related settings.

The controller node(s) 700 may comprise processing module(s) 701, such as a means, one or more hardware modules, including e.g. one or more processors, and/or one or more software modules for performing said method and/or actions.

The controller node(s) 700 may further comprise memory 702 that may comprise, such as contain or store, computer program(s) 703. The computer program(s) 703 comprises ‘instructions’ or ‘code’ directly or indirectly executable by the controller node(s) 700 to perform said method and/or actions. The memory 702 may comprise one or more memory units and may further be arranged to store data, such as configurations and/or applications involved in or for performing functions and actions of embodiments herein.

Moreover, the controller node(s) 700 may comprise processor(s) 704, i.e. one or more processors, as exemplifying hardware module(s) and may comprise or correspond to one or more processing circuits. In some embodiments, the processing module(s) 701 may comprise, e.g. ‘be embodied in the form of’ or ‘realized by’ processor(s) 704. In these embodiments, the memory 702 may comprise the computer program 703 executable by the processor(s) 704, whereby the controller node(s) 700 is operative, or configured, to perform said method and/or actions.

Typically the controller node(s) 700, e.g. the processing module(s) 701, comprises Input/Output (I/O) module(s) 705, configured to be involved in, e.g. by performing, any communication to and/or from other network nodes and/or units and/or devices, such as sending and/or receiving information to and/or from other nodes. The I/O module(s) 705 may be exemplified by obtaining, e.g. receiving, module(s) and/or providing, e.g. sending, module(s), when applicable.

Further, in some embodiments, the controller node(s) 700, e.g. the processing module(s) 701, comprises one or more of an obtaining module(s), receiving module(s), sending module(s), determining module(s), controlling module(s), as exemplifying hardware and/or software module(s) for carrying out actions of embodiments herein. These modules may be fully or partly implemented by the processor(s) 704.

Hence:

The controller node(s) 700, and/or the processing module(s) 701, and/or the processor(s) 704, and/or the I/O module(s) 705, and/or the sending module(s) are operative, or configured, to send, to the radio node 150, said message identifying said first one or more subsets of said supported operative set of radio related settings, which first one or more subsets are the only of said supported operative set that the radio node 150 temporarily needs to be prepared to operate according to.

The controller node(s) 700, and/or the processing module(s) 701, and/or the processor(s) 704, and/or the I/O module(s) 705, and/or the obtaining module(s) may be operative, or configured, to obtain said capability information identifying said supported operative set.

The controller node(s) 700, and/or the processing module(s) 701, and/or the processor(s) 704, and/or the determining module(s) may be operative, or configured, to determine said first one or more subsets from said supported operative set based on what radio related settings are temporarily sufficient for operation by the radio node 150.

The controller node(s) 700, and/or the processing module(s) 701, and/or the processor(s) 704, and/or the I/O module(s) 705, and/or the obtaining module(s) may be operative, or configured, to obtain said multiple subsets information identifying multiple subsets of said supported operative set, wherein said first one or more subsets identified by the message are identified based on said multiple subsets.

The controller node(s) 700, and/or the processing module(s) 701, and/or the processor(s) 704, and/or the I/O module(s) 705, and/or the sending module(s) may be operative, or configured, to send, to the radio node 150, said deactivation and/or subset switch information indicating when said first one or more subsets identified by the message no longer apply as the only of said supported operative set that the radio node 150 needs to be prepared to operate according to.

The controller node(s) 700, and/or the processing module(s) 701, and/or the processor(s) 704, and/or the I/O module(s) 705, and/or the controlling module(s) may be operative, or configured, to control the radio node 150 with said temporary restriction to said first one or more subsets in accordance with the sent message.

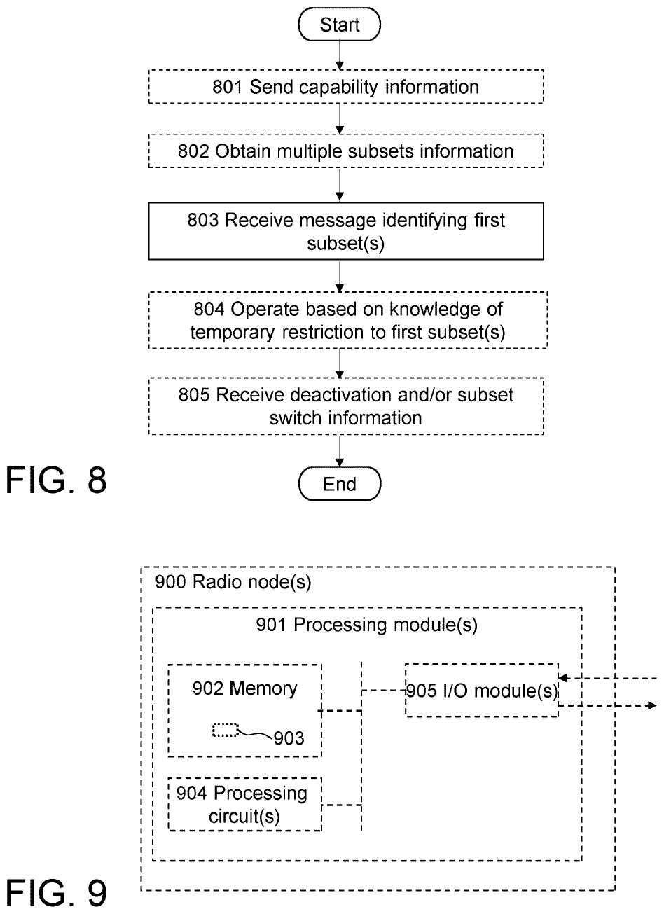

FIG. 8 is a flowchart schematically illustrating embodiments of a second method, performed by a radio node, according to embodiments herein.

The method is for supporting energy saving by the radio node that is a radio node that has ability and is controllable by the controller node to operate using radio related settings according to a supported operative set of radio related settings. In the following said controller node is exemplified by the controller node 250 and said radio node is exemplified by the radio node 150.

The actions below that may form the method may be taken in any suitable order and/or be carried out fully or partly overlapping in time when this is possible and suitable.

### Action 801

The radio node 150 may send, to the controller node 250, capability information identifying said supported operative set.

This action may fully or partly correspond to one or more of Actions 302, 401, 501.

### Action 802

The radio node 150 may obtain multiple subsets information identifying multiple subsets of said supported operative set.

In some embodiments, said multiple subsets information is obtained by being received from the controller node 250.

In some embodiments, said multiple subsets information is obtained by being configured by the radio node 150 based on said supported operative set, and wherein the controller node 250 is informed about the configured multiple subsets, e.g. by that the radio node 150 sends said configured multiple subsets information to the controller node 250. In some of these embodiments, the radio node 150 is informed about new subsets that the controller node 250 has configured based on the configured multiple subsets information that the controller mode 250 was informed about.

This action may fully or partly correspond to one or more of Actions 303, 401, 501-505.

### Action 803

The radio node 150 receives, from the controller node 250, a message identifying first one or more subsets of said supported operative set of radio related settings. Said first one or more subsets being identified as the only of said supported operative set that the radio node 150 temporarily needs to be prepared to operate according to.

In embodiments where multiple subsets information is obtained as in Action 802, said first one or more subsets may be identified by the message based on said multiple subsets.

This action may fully or partly correspond to one or more of Actions 305, 402.

### Action 804

The radio node 150 may operate, e.g. with energy saving, based on knowledge of temporary restriction in the control by the controller mode 250 to said first one or more subsets in accordance with the received message.

This action may fully or partly correspond to one or more of Actions 307, 312, 404-405.

### Action 805

The radio node 150 may receive, from the controller node 250, deactivation and/or subset switch information indicating when said first one or more subsets identified by the message no longer apply as the only of said supported operative set that the radio node 150 needs to be prepared to operate according to.

In some embodiments, the deactivation and/or subset switch information indicates:
when another message, identifying second one or more subsets of said supported operative set of radio related settings, can be expected, and/or
when second one or more subsets of said supported operative set of radio related settings apply, whereafter said second one or more subsets will be the only of said supported operative set that the radio node 150 temporarily needs to be prepared to operate according to.

This action may fully or partly correspond to one or more of Actions 308, 406.

FIG. 9 is a schematic block diagram for illustrating embodiments of how one or more radio nodes, e.g. devices, 900 may be configured to perform the method and actions discussed in connection with FIG. 8. The radio node(s) 900 may be physical node(s) that correspond to or comprises the radio node 150. As already indicated above for the radio node 150, in some embodiments, the radio node(s) 900 may thus be or correspond to a radio network node, e.g. the radio network node 110, of a wireless communication network, e.g. the wireless communication network 100. The radio network node being configured to serve one or more wireless communication devices, e.g. the wireless communication devices 120a-c.

In embodiments where the radio node 150 is a logical node, what is disclosed in relation to FIG. 9 may relate to how the radio node(s) 900 may be configured to make the radio node 150 perform the method and actions discussed in connection with FIG. 8. In order to facilitate relating what is being described below to what has already been described above in relation to FIG. 8, the radio node 150 may be used to exemplify the radio node(s) 900, i.e. they may be used interchangeably.

Hence, the radio node(s) 900 is for supporting energy saving by the radio node 150, the radio node 150 having ability and being controllable by the controller node 250 to operate using radio related settings according to said supported operative set of radio related settings

The radio node(s) 900 may comprise processing module(s) 901, such as a means, one or more hardware modules, including e.g. one or more processors, and/or one or more software modules for performing said method and/or actions.

The radio node(s) 900 may further comprise memory 902 that may comprise, such as contain or store, computer program(s) 903. The computer program(s) 903 comprises ‘instructions’ or ‘code’ directly or indirectly executable by the radio node(s) 900 to perform said method and/or actions. The memory 902 may comprise one or more memory units and may further be arranged to store data, such as configurations and/or applications involved in or for performing functions and actions of embodiments herein.

Moreover, the radio node(s) 900 may comprise processor(s) 904, i.e. one or more processors, as exemplifying hardware module(s) and may comprise or correspond to one or more processing circuits. In some embodiments, the processing module(s) 901 may comprise, e.g. ‘be embodied in the form of’ or ‘realized by’ processor(s) 904. In these embodiments, the memory 902 may comprise the computer program 903 executable by the processor(s) 904, whereby the radio node(s) 900 is operative, or configured, to perform said method and/or actions.

Typically the radio node(s) 900, e.g. the processing module(s) 901, comprises Input/Output (I/O) module(s) 905, configured to be involved in, e.g. by performing, any communication to and/or from other network nodes and/or units and/or devices, such as sending and/or receiving information to and/or from other nodes. The I/O module(s) 905 may be exemplified by obtaining, e.g. receiving, module(s) and/or providing, e.g. sending, module(s), when applicable.

Further, in some embodiments, the radio node(s) 900, e.g. the processing module(s) 901, comprises one or more of an obtaining module(s), receiving module(s), sending module(s), operating module(s), as exemplifying hardware and/or software module(s) for carrying out actions of embodiments herein. These modules may be fully or partly implemented by the processor(s) 904.

Hence:

The radio node(s) 900, and/or the processing module(s) 901, and/or the processor(s) 904, and/or the I/O module(s) 905, and/or the receiving module(s) are operative, or configured, to receive, from the controller node 250, said message identifying said first one or more subsets of said supported operative set of radio related settings, which first one or more subsets are the only of said supported operative set that the radio node 150 temporarily needs to be prepared to operate according to.

The radio node(s) 900, and/or the processing module(s) 901, and/or the processor(s) 904, and/or the I/O module(s) 905, and/or the sending module(s) may be operative, or configured, to send, to the controller node 250, said capability information identifying said supported operative set.

The radio node(s) 900, and/or the processing module(s) 901, and/or the processor(s) 904, and/or the I/O module(s) 905, and/or the obtaining module(s) may be operative, or configured, to obtain said multiple subsets information identifying multiple subsets of said supported operative set, wherein said first one or more subsets identified by the message are identified based on said multiple subsets.

The radio node(s) 900, and/or the processing module(s) 901, and/or the processor(s) 904, and/or the I/O module(s) 905, and/or the receiving module(s) may be operative, or configured, to receive, from the controller node 250, said deactivation and/or subset switch information indicating when said first one or more subsets identified by the message no longer apply as the only of said supported operative set that the radio node 150 needs to be prepared to operate according to.

The radio node(s) 900, and/or the processing module(s) 901, and/or the processor(s) 904, and/or the I/O module(s) 905, and/or the operating module(s) may be operative, or configured, to operate based on knowledge of temporary restriction in the control by the controller mode 250 to said first one or more subsets in accordance with the received message.

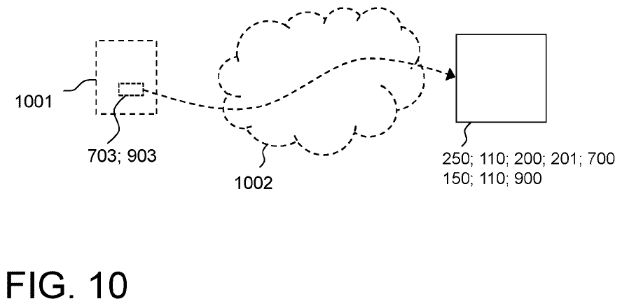

FIG. 10 is a schematic drawing illustrating some embodiments relating to computer program(s) and carrier(s) thereof to cause said controller node(s) 700 and/or radio node(s) 900 discussed above to perform the associated methods and actions, respectively. The computer program(s) may be the computer program 703 and/or 903 and comprises instructions that when executed by the processing circuit(s) 704 and/or 904 and/or the processing module(s) 701 and/or 901, causes the controller node(s) 700 and/or radio node(s) 900 to perform as described above. In some embodiments there is provided a carrier, or more specifically a data carrier, e.g. a computer program product, comprising the computer program. The carrier may be one of an electronic signal, an optical signal, a radio signal, and a computer readable storage medium, e.g. a computer readable storage medium 1001 as schematically illustrated in the figure. One or more of the computer programs 703, 903 may thus be stored on the computer readable storage medium 1001. By carrier may be excluded a transitory, propagating signal and the data carrier may correspondingly be named non-transitory data carrier. Non-limiting examples of the data carrier being a computer readable storage medium is a memory card or a memory stick, a disc storage medium such as a CD or DVD, or a mass storage device that typically is based on hard drive(s) or Solid State Drive(s) (SSD). The computer readable storage medium 1001 may be used for storing data accessible over a computer network 1002, e.g. the Internet or a Local Area Network (LAN). One or more of the computer programs 703, 903 may furthermore be provided as pure computer program(s) or comprised in a file or files. The file or files may be stored on the computer readable storage medium 1001 and e.g. available through download e.g. over the computer network 1002 as indicated in the figure, e.g. via a server. The server may e.g. be a web or File Transfer Protocol (FTP) server. The file or files may e.g. be executable files for direct or indirect download to and execution on said controller node(s) 700 and/or radio node(s) 900 to cause performance as described above, e.g. by execution by the processing circuit(s) 704 and/or 904. The file or files may also or alternatively be for intermediate download and compilation involving the same or another processor to make them executable before further download and execution causing said controller node(s) 700 and/or radio node(s) 900 to perform as described above.

Note that any processing module(s) and circuit(s) mentioned in the foregoing may be implemented as a software and/or hardware module, e.g. in existing hardware and/or as an Application Specific Integrated Circuit (ASIC), a field-programmable gate array (FPGA) or the like. Also note that any hardware module(s) and/or circuit(s) mentioned in the foregoing may e.g. be included in a single ASIC or FPGA, or be distributed among several separate hardware components, whether individually packaged or assembled into a System-on-a-Chip (SoC).

Those skilled in the art will also appreciate that the modules and circuitry discussed herein may refer to a combination of hardware modules, software modules, analogue and digital circuits, and/or one or more processors configured with software and/or firmware, e.g. stored in memory, that, when executed by the one or more processors may make any node(s), device(s), apparatus(es), network(s), system(s), etc. to be configured to and/or to perform the above-described methods and actions.

Identification by any identifier herein may be implicit or explicit. The identification may be unique in a certain context, e.g. in the wireless communication network or at least in a relevant part or area thereof.

The term “network node” or simply “node” as used herein may as such refer to any type of node that may communicate with another node in and be comprised in a communication network, e.g. Internet Protocol (IP) network or wireless communication network. Further, such node may be or be comprised in a radio network node (described below) or any network node, which e.g. may communicate with a radio network node. Examples of such network nodes include any radio network node, a core network node, Operations & Maintenance (O&M), Operations Support Systems (OSS), Self-Organizing Network (SON) node, etc.

The term “radio network node” as may be used herein may as such refer to any type of network node for serving a wireless communication device, e.g. a so called User Equipment or UE, and/or that are connected to other network node(s) or network element(s) or any radio node from which a wireless communication device receives signals from. Examples of radio network nodes are Node B, Base Station (BS), Multi-Standard Radio (MSR) node such as MSR BS, eNB, eNodeB, gNB, network controller, RNC, Base Station Controller (BSC), relay, donor node controlling relay, Base Transceiver Station (BTS), Access Point (AP), New Radio (NR) node, transmission point, transmission node, node in distributed antenna system (DAS) etc.

Each of the terms “wireless communication device”, “wireless device”, “user equipment” and “UE”, as may be used herein, may as such refer to any type of wireless device arranged to communicate with a radio network node in a wireless, cellular and/or mobile communication system. Examples include: target devices, device to device UE, device for Machine Type of Communication (MTC), machine type UE or UE capable of machine to machine (M2M) communication, Personal Digital Assistant (PDA), tablet, mobile, terminals, smart phone, Laptop Embedded Equipment (LEE), Laptop Mounted Equipment (LME), Universal Serial Bus (USB) dongles etc.

While some terms are used frequently herein for convenience, or in the context of examples involving other a certain, e.g. 3GPP or other standard related, nomenclature, it must be appreciated that such term as such is non-limiting

Also note that although terminology used herein may be particularly associated with and/or exemplified by certain communication systems or networks, this should as such not be seen as limiting the scope of the embodiments herein to only such certain systems or networks etc.

As used herein, the term “memory” may refer to a data memory for storing digital information, typically a hard disk, a magnetic storage, medium, a portable computer diskette or disc, flash memory, random access memory (RAM) or the like. Furthermore, the memory may be an internal register memory of a processor.

Also note that any enumerating terminology such as first device or node, second device or node, first base station, second base station, etc., should as such be considered non-limiting and the terminology as such does not imply a certain hierarchical relation. Without any explicit information in the contrary, naming by enumeration should be considered merely a way of accomplishing different names.

As used herein, the expression “configured to” may e.g. mean that a processing circuit is configured to, or adapted to, by means of software or hardware configuration, perform one or more of the actions described herein.

As used herein, the terms “number” or “value” may refer to any kind of digit, such as binary, real, imaginary or rational number or the like. Moreover, “number” or “value” may be one or more characters, such as a letter or a string of letters. Also, “number” or “value” may be represented by a bit string.

As used herein, the expression “may” and “in some embodiments” has typically been used to indicate that the features described may be combined with any other embodiment disclosed herein.

In the drawings, features that may be present in only some embodiments are typically drawn using dotted or dashed lines.

As used herein, the expression “transmit” and “send” are typically interchangeable. These expressions may include transmission by broadcasting, uni-casting, group-casting and the like. In this context, a transmission by broadcasting may be received and decoded by any authorized device within range. In case of unicasting, one specifically addressed device may receive and encode the transmission. In case of group-casting, e.g. multicasting, a group of specifically addressed devices may receive and decode the transmission.

When using the word “comprise” or “comprising” it shall be interpreted as nonlimiting, i.e. meaning “consist at least of”.

The embodiments herein are not limited to the above described preferred embodiments. Various alternatives, modifications and equivalents may be used. Therefore, the above embodiments should not be taken as limiting the scope of the present disclosure, which is defined by the appending claims.

1. A method, performed by a controller node (250; 700), for controlling a radio node (150; 900) to support energy saving by the radio node (150; 900), the radio node (150; 900) having ability and being controllable by the controller node (250; 700) to operate using radio related settings according to a supported operative set of radio related settings, wherein the method comprises:
sending (305; 604), to the radio node (150; 900), a message identifying first one or more subsets of said supported operative set of radio related settings, which first one or more subsets are the only of said supported operative set that the radio node (150; 900) temporarily needs to be prepared to operate according to.

2. The method as claimed in claim 1, wherein the method further comprises:
obtaining (302; 601) capability information identifying said supported operative set.

3. The method as claimed in claim 2, wherein the capability information is obtained by being received from the radio node (150; 900).

4. The method as claimed in claim 1, wherein the method further comprises:
determining (304; 603) said first one or more subsets from said supported operative set based on what radio related settings are temporarily sufficient for operation by the radio node (150; 900).

5. The method as claimed in claim 1, wherein the method further comprises:
obtaining (303; 602) multiple subsets information identifying multiple subsets of said supported operative set, and wherein said first one or more subsets identified by the message are identified based on said multiple subsets.

6. The method as claimed in claim 5, wherein said multiple subsets information is obtained by being received from the radio node (150; 900).

7-16. (canceled)

17. Computer program (703) comprising instructions that when executed by one or more processors (704) causes a controller node (250; 110; 200; 201; 700) to perform the method according to claim 1.

18. Carrier comprising the computer program (703) according to claim 17, wherein the carrier is one of an electronic signal, optical signal, radio signal or computer readable storage medium (1001).

19. A controller node (250; 700) for controlling a radio node (150; 900) to support energy saving by the radio node (150; 900), the radio node (150; 900) having ability and being controllable by the controller node (250; 700) to operate using radio related settings according to a supported operative set of radio related settings, wherein the controller node (250; 700) is configured to send (305; 604), to the radio node (150; 900), a message identifying first one or more subsets of said supported operative set of radio related settings, which first one or more subsets are the only of said supported operative set that the radio node (150; 900) temporarily needs to be prepared to operate according to.

20. The controller node (250; 700) as claimed in claim 19, wherein the controller node (250; 700) is further configured to obtain (302; 601) capability information identifying said supported operative set.

21. The controller node (250; 700) as claimed in claim 20, wherein the capability information is obtained by receipt from the radio node (150; 900).

22. The controller node (250; 700) as claimed in claim 19, wherein the controller node (250; 700) if further configured to determine (304; 603) said first one or more subsets from said supported operative set based on what radio related settings are temporarily sufficient for operation by the radio node (150; 900).

23. The controller node (250; 700) as claimed in claim 19, wherein the controller node (250; 700) is further configured to obtain (303; 602) multiple subsets information identifying multiple subsets of said supported operative set, and wherein said first one or more subsets identified by the message are identified based on said multiple subsets.

24. The controller node (250; 700) as claimed in claim 23, wherein said multiple subsets information is obtained by receipt from the radio node (150; 900).

25-64. (canceled)
